(19) United States
(12) Patent Application Publication
(10) Pub. No.: US 2026/0093535 A1
(43) Pub. Date: Apr. 2, 2026

(54) EDGE CROSS EXTERNAL FABRIC PROVIDER FRAMEWORK FOR MULTI EXTERNAL FABRICS INTERACTIONS

(71) Applicant: Dell Products L.P., Round Rock, TX (US)

(72) Inventors: MAXIM BALIN, Gan-Yavne (IL); ALEXANDER MOLEV, Beer Yaakov (IL)

(21) Appl. No.: 18/899,203

(22) Filed: Sep. 27, 2024

(51) Int. Cl. G06F 9/50

(52) U.S. Cl. CPC G06F 9/5027

(57) ABSTRACT

Methods and systems for managing command processing for a data processing system are disclosed. An identification may be made that the data processing system has issued a command requesting a computer-implemented service provided by at least one of a set of external providers. Based on the identification, an external provider (of the set of external providers) may be identified based on the requested computer-implemented service and supplemental information associated with the command (e.g., security standards). The command may be modified (e.g., processed, translated) based on a schema for the external provider and/or in accordance with the supplemental information, and execution of the modified command (by at least the external provider) may be initiated to facilitate provisioning of the requested computer-implemented service.

### FIELD

Embodiments disclosed herein relate generally to managing operation of data processing systems. More particularly, embodiments disclosed herein relate to systems and methods to manage command processing for the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a data flow diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing command processing for a data processing system. The data processing system may provide computer-implemented services based on commands issued to and/or by the data processing system. For example, the data processing system may provide the computer-implemented services in coordination with external providers (e.g., external resource systems). To do so, the data processing system may issue commands requesting a computer-implemented service provided by one or more external providers.

The external providers may be managed by an entity different to a managing entity of the data processing system. For example, the external providers may include external fabric providers and/or other types of providers of data storage services, data processing services (e.g., computing resources), and/or other types of services.

In order to utilize (e.g., request) computer-implemented services offered by the external providers, commands issued to the external providers (e.g., from the data processing system) may be required to adhere to specifications managed and controlled exclusively by the external providers. However, different external providers may use different application protocol interfaces (APIs) when providing their services, and the API requirements may vary among the services, complicating use of the computer-implemented services.

For example, commands issued to different external providers may require different command syntax and/or different informational content in order to successfully obtain computer-implemented services provided by the external providers. Therefore, large numbers of different commands may be required to be known (e.g., learned by users of the data processing system) and/or added to existing infrastructure (e.g., by altering core code) in order to invoke the external computer-implemented services. However, relying on these methods may lead to mistakes (e.g., by unseasoned users), misconfigurations (e.g., of the core code), and/or a decreased quality of the computer-implemented services. For example, the data processing system may be unable to provide the computer-implemented services as desired.

Thus, to improve the likelihood of providing the desired computer-implemented services in coordination with external providers, a management framework for interfacing with the external providers may be implemented. The management framework may provide a unified interface for interacting with different external providers that removes a need for identifying differing API requirements and/or modifying core code of existing infrastructure. The unified interface may define unified interface command templates (e.g., defining command syntax and/or command content) in order to limit the number of commands required to be known by users and/or to be processed by existing infrastructure.

Unified interface commands issued to the external providers may be identified, analyzed, and/or modified as necessary using schemas associated with each of the external providers. The schemas may use information from the unified interface commands and/or supplemental information to automatically translate the unified interface commands to commands recognized by the external providers. When a new external provider is added, new schemas associated with services of the new provider may be defined and later utilized during command processing.

By doing so, the management framework may offer methods for improving resource use (e.g., cost optimization), flexibility in changing and/or adding new external providers, and for reducing operational complexity when invoking the computer-implemented services.

In an embodiment, a method for managing command processing for a data processing system is provided. The method may include making an identification that the data processing system has issued a command, the command requesting a computer-implemented service, and the computer-implemented service being provided by at least one of a set of external providers.

The method may include, based on the identification: identifying an external provider of the set of external providers based on the requested computer-implemented service and supplemental information associated with the command; modifying the command based on a schema for the external provider; and, initiating execution of the modified command by at least the external provider to facilitate provisioning of the requested computer-implemented service.

The supplemental information may include security standards, and the command may be modified based at least on the security standards to improve compliance with the security standards.

The supplemental information may include information regarding classifications for invokers of commands issuable by the data processing system, each of the classifications establishing minimum levels of compliance with the security standards for modified commands that are based on the commands, and the command may be modified also based on a minimum level of compliance of the minimum levels of compliance corresponding to an invoker of the invokers that invoked the command.

The supplemental information may be defined, at least in part, by an administrator tasked with the managing of the command processing using the set of the external providers and the administrator may be different from the invoker.

Each external provider of the set of external providers may provide computer-implemented services using an application protocol interface. Application protocol interfaces of the set of external providers may differ from one another and may be controlled exclusively by the set of external providers.

The schema for the external provider may be adapted to translate the command to the modified command using command mappings defined by the schema, the command mappings being based on an application protocol interface of the external provider. The schema may be a member of a schema repository comprising a plurality of schemas for the set of external providers.

The command may be issued based on a command template of a repository of command templates, the command template being associated with the requested computer-implemented service.

A non-transitory media may include instructions that when executed by a processor cause the computer-implemented method to be performed.

A data processing system may include the non-transitory media and a processor, and may perform the computer-implemented method when the computer instructions are executed by the processor.

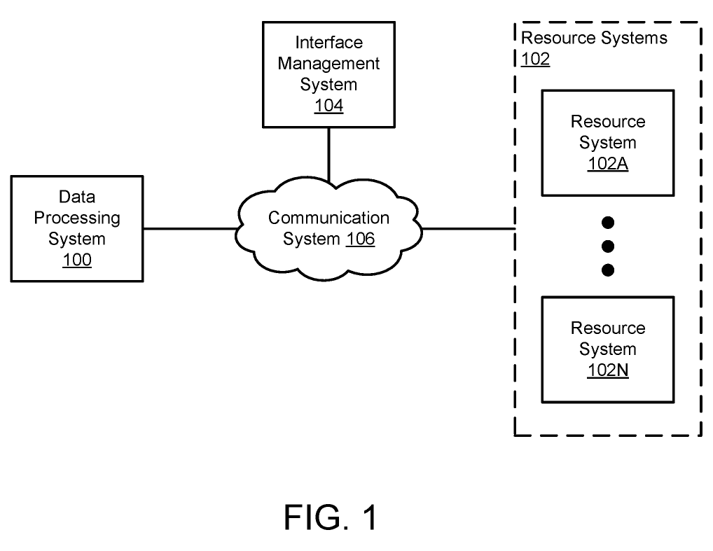

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided via cooperative interaction between data processing systems. For example, data processing system 100 may interact with any external providers (e.g., resource systems 102) when providing the computer-implemented services.

To facilitate interactions between systems, commands (e.g., computer instructions) may be issued by and/or any of the systems. For example, data processing system 100 may issue commands to resource system 102A requesting computer-implemented services. Based on an interpretation of the commands, hardware components of resource system 102A may support execution of any number and/or types of software components (e.g., applications hosted by the hardware components) in order to provide the requested computer-implemented service. However, if the commands are not interpretable by resource system 102A, then the requested computer-implemented service may not be provided.

For example, resource system 102A may use an API managed and/or controlled by an operator of resource system 102A. The API for resource system 102A may require specific instructions in order to invoke its provided services. For example, the API for resource system 102A may only be able to interpret a specific type of command syntax and/or command content; therefore, data processing system 100 may be required to issue the command in accordance with the API requirements in order to successfully obtain a requested service from resource system 102A.

Each of resource systems 102 (e.g., 102A-102N) may use APIs that differ from one another, and may be controlled exclusively by each (operator of) resource systems 102. Further, each of resource systems 102 may offer different services, and the difference services may be invoked using different sets of instructions. Thus, in order for data processing system 100 to obtain services from multiple external providers (e.g., resource systems 102), data processing system 100 may be required to issue large numbers of different commands in accordance with each of the different APIs. This may present a challenge for unseasoned users of data processing system 100 and/or for developers who may be tasked with maintaining core code for services used by data processing system 100.

For example, the users may be required to learn and distinguish the large numbers of different commands and/or the developers may be required to continuously update core code in order to reflect the different API requirements. This may increase a likelihood of errors, inefficient use of third-party services (e.g., cost implications), and/or undesired modifications to the core code, and as a result, desired computer-implemented services may not be provided timely.

Therefore, to increase the likelihood of providing timely and desired computer-implemented services, a management framework for interfacing with multiple external providers may be provided. The management framework may facilitate a unified interface for interactions with the multiple external providers that manages differences in communication requirements among the external providers.

In general, embodiments disclosed herein may provide methods, systems, and/or devices for facilitating communication between data processing systems and resource systems operated by multiple external providers in a manner that reduces cognitive requirements of users (e.g., developers, administrators) of the data processing systems.

To do so, the management framework may define unified interface commands usable to request services from external providers. When issued by a data processing system, a unified interface command may be used to identify an external provider from which a service may be requested. The unified interface command may then be translated to (a) modified command(s) executable by the identified external provider using a schema associated with the external provider. For example, the schema may define command mappings based on an API of the external provider usable to map the unified interface command to the modified command.

A repository of schemas may be managed for use in command processing (e.g., translation), allowing for new schemas to be added (e.g., for new external providers and/or services) and/or existing schemas to be modified. The schemas may be adapted by modify (e.g., translate) unified interface commands based on APIs of external providers as well as supplemental information (e.g., organizational standards for the data processing system).

By doing so, cognitive burden on users of the data processing system may be decreased, and/or a likelihood of introducing errors when altering core code of the data processing system may be reduced. The management framework may also provide for improvement in compliance with security, legal, cost, and/or other organizational standards when obtaining services from the external providers.

To provide the above-mentioned functionality, the system of FIG. 1 may include data processing system 100, resource systems 102, interface management system 104, and communication system 106. The system, any components thereof, and/or any other types of devices or components not shown in FIG. 1 may perform all, or a portion of the computer-implemented services independently and/or cooperatively. Each of these components is discussed below.

Data processing system 100 may include any number of data processing systems that may subscribe to third-party services provided by resource systems 102. Data processing system 100 may be operated by a user, and the user may invoke commands for obtaining third-party services from any of resource systems 102. For example, data processing system 100 may issue commands indicating that a computer-implemented service is requested. The commands issued by data processing system 100 may include unified interface commands. The unified interface commands may not be executable by any of resource systems 102.

Resource systems 102 may include any number of resources systems (e.g., 102A-102N), and may provide any number of computer-implemented services to data processing system 100. For example, resource systems 102 may include external fabric providers and/or may provide data storage services, data processing services, and/or other types of services. To provide the services, each of resource systems 102 may utilize different APIs to communicate with data processing system 100, and the APIs may differ based on the type of computer-implemented service. For example, a data storage service provided by resource system 102A may utilize a first API that requires a first set of instructions (e.g., a first command) to obtain the data storage service, and a data processing service provided by resource system 102A may utilize a second API that requires a second set of instructions (e.g., a second command) to obtain the data processing service.

To manage communication requirements for obtaining services from resource systems 102, the management framework may include interface management system 104. Interface management system may, for example, manage and/or access (i) a repository of templates from which unified interface commands may be selected, (ii) a repository of schemas for each service for each of resource systems 102 usable to modify the unified interface commands, and/or (iii) other data structures used for command processing.

Interface management system 104 may use schemas from the schema repository to dynamically translate commands (e.g., unified interface commands) based on mappings of the schemas. For example, interface management system 104 may dynamically load the schemas (e.g., as plugins) during command processing. Interface management system 104 may also facilitate updating (e.g., modification), removal, and/or addition of the schemas (e.g., by an administrator of data processing system 100) to reflect changes in external providers and/or their services. By doing so, potentially hazardous and/or frequent modifications to core code (of data processing system 100) may be avoided.

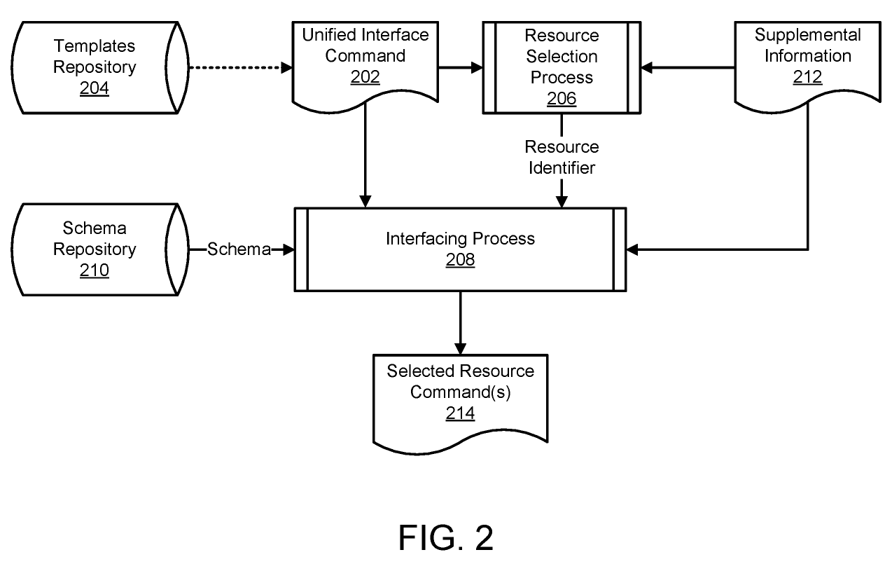

To manage command processing for data processing system 100, interface management system 104 may (i) identify issuance of a command requesting a third-party service by data processing system 100, (ii) identify an external provider based on the command and/or supplemental information associated with the command (e.g., information regarding an invoker of the command and/or organizational standards for data processing system 100), (iii) identify a schema for the external provider (and the requested service), (iv) modify the command based on the identified schema, (v) initiate execution of the modified command (e.g., by the external provider) to facilitate the requested third-party service, and/or (vi) perform other actions for facilitating third-party services for data processing system 100 (e.g., perform error handling and/or obtain user feedback). Refer to the discussion of FIG. 2 for more details regarding command processing.

By doing so, interface management system 104 may automatically reflect changes made to external providers and/or their services (e.g., via schema updates), without relying on human cognition. As a result, the computer-implemented services may be more likely to be provided in a desired manner (e.g., in accordance with organizational standards).

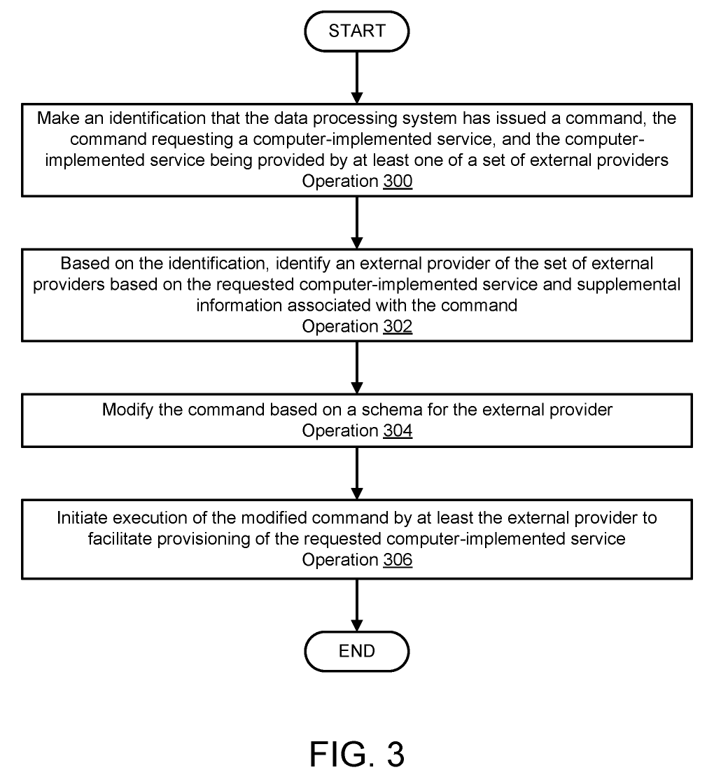

When providing their functionality, any of data processing system 100, resource systems 102, interface management system 104, and/or components thereof may perform all, or a portion of the actions and methods illustrated in FIGS. 2-3.

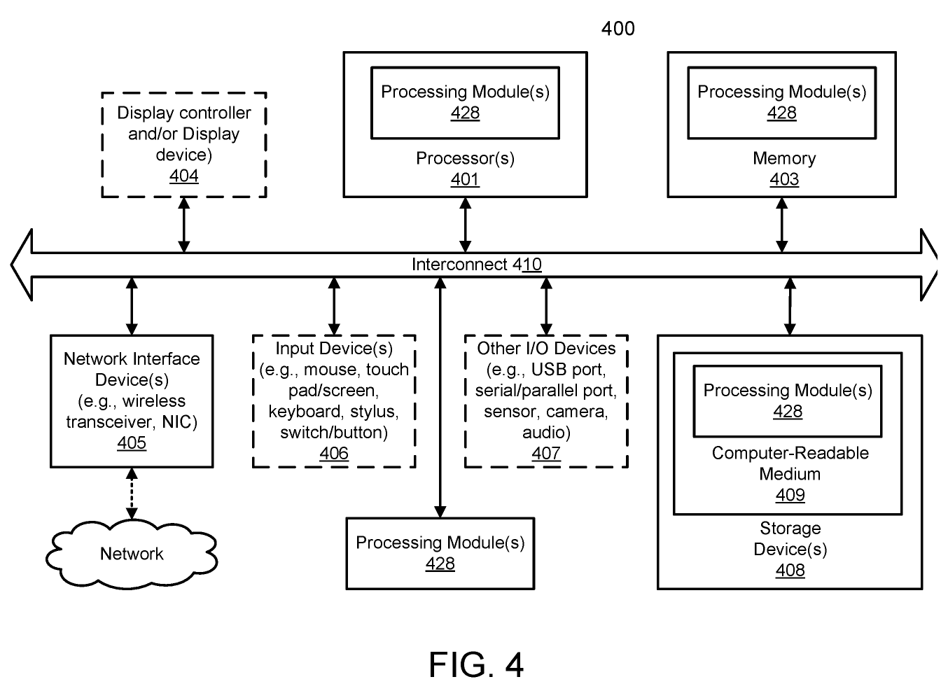

Any of data processing system 100, resource systems 102, and interface management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, a data flow diagram in accordance with an embodiment is shown in FIG. 2. In this diagram, flows of data and processing of data are illustrated using different sets of shapes. A first set of shapes (e.g., 202, 212, etc.) is used to represent data structures, a second set of shapes (e.g., 206, 208) is used to represent processes performed using and/or that generate data, and a third set of shapes (e.g., 204, 210) is used to represent large scale data structures such as databases. Arrows drawn between shapes may indicate a direction of a flow of data. Arrows drawn in dashing may indicate flows of data that are optional and/or that may only occur under some circumstances.

Turning to FIG. 2, the data flow diagram shown may illustrate data used in and data processing performed in managing command processing for a data processing system.

To manage command processing, a management system (e.g., similar to interface management system 104 of FIG. 1) may identify that a command requesting a computer-implemented service (e.g., a third-party service provided by an external provider) has been issued by the data processing system. For example, as shown in FIG. 2, the command may include unified interface command 202.

Unified interface command 202 may be issued based on a command template from templates repository 204. Templates repository 204 may include any number of command templates associated with services provided by external providers. For example, the command templates may be structured in a predefined manner (e.g., that allows subsequent processes to appropriately parse populated command templates) and/or may be customizable. The command templates may be pre-populated with information required for requesting the service and/or may be required to be populated with such information. Thus, in a first example, unified interface command 202 may include a pre-populated command template.

In a second example, a user of the data processing system may select a command template from template repository 204. The command template may be selected based on a type of the service being requested and/or any other criterion. The user may provide user input via an interface such as a command line interface in order to populate the command template. To customize the command template, the user may provide additional information that my indicate constraints and/or activate options associated with the requested service. The additional information may be provided in accordance with the predefined structure of the command template. The command template may be populated and/or customized (e.g., by the user or another entity such as a data processing system) in order to obtain unified interface command 202.

Unified interface command 202 may be invoked by the data processing system via execution of a sequence of instructions (e.g., a batch file that includes or calls unified interface command 202) and/or by the user of the data processing system. Unified interface command 202 may include instructions for invoking the requested service. By using unified interface command 202 to request services, the management framework for managing command processing may remain provider-agnostic (e.g., at the invoker level). As a result, users may not be required to modify code and/or learn new command syntax when new external providers are added or when external providers modify their APIs.

Once the management system has identified issuance of unified interface command 202, the management system may identify an external provider suitable for providing the requested service. For example, the data processing system may use various services from multiple external providers (e.g., a set of external providers). To identify the external provider from the set of external providers, resource selection process 206 may be performed.

During resource selection process 206, information included in unified interface command 202 and/or supplemental information associated with unified interface command 202 (e.g., supplemental information 212) may be used to identify the external provider. For example, unified interface command 202 may be parsed and/or analyzed in order to identify information regarding the requested service (e.g., a type of service requested, a type and/or number of resources requested for performing the service). External providers that offer the requested service in accordance with the identified information may be considered as external provider candidates.

Supplemental information 212 may include, for example, information regarding security standards, legal standards, and/or other organizational standards or policies (e.g., cost or expense policies). For example, supplemental information 212 may be used to manage authentication, security, and/or resource provisioning for external providers. Supplemental information 212 may be defined, at least in part, by an administrator tasked with managing command processing for the data processing system using a set of external providers and/or by other entities. Supplemental information 212 may indicate security clearance levels, permissions levels, and/or cost authorization levels that may guide and/or limit selection of the external provider from the external provider candidates.

For example, an external provider may be selected based on security requirements (e.g., some external providers may not be authorized to process or store sensitive data), based on cost policies (e.g., some external providers may be more cost-effective than others), etc. In other words, an external provider may be selected in a manner that improves security, cost control, and/or resource allocation based on supplemental information 212. Once identified, during resource selection process 206, a resource identifier may be obtained. The resource identifier may be associated with the identified external provider and may be provided to other processes (e.g., interfacing process 208).

Unified interface command 202 may not be natively executable by (e.g., known to) the identified external provider. For example, each external provider of the set of external providers may provide services using an API. APIs of the set of external providers may differ from one another and may be controlled exclusively by the set of external providers (e.g., not an administrator and/or user of the data processing system). Therefore, unified interface command 202 may not meet requirements of the API of the identified external provider and may require modification in order to meet the requirements and thereby become executable by the identified external provider.

To modify unified interface command 202, interfacing process 208 may be performed. During interfacing process 208, unified interface command 202 may be modified based on at least supplemental information 212. For example, interfacing process 208 may be performed using the resource identifier (e.g., from resource selection process 206), a schema from schema repository 210, and/or supplemental information 212. During interfacing process 208, the schema may be selected from schema repository 210 based on the resource identifier and the requested service (e.g., the schema may be associated with the identified external provider). The selected schema (and other schemas of schema repository 210) may be pre-loaded (e.g., made available to the management system at startup) and stored externally to core code of the management system so that interfacing process 208 may be performed timely using the selected schema (e.g., without requiring restart of the management system).

Schema repository 210 may include any number of schemas associated with external provider and/or their services. The schemas stored in schema repository 210 may be adapted to translate commands to modified commands using command mappings defined by the schemas. The schemas may be versioned and may be updated over time to reflect changes to external providers and/or varying API requirements. For example, the command mappings for the schema associated with the external provider may be based on an API for the identified external provider and may be used to guide translation of portions of command syntax and/or may modify command content of unified interface command 202 to reflect requirements of the API for the identified external provider.

The translation of unified interface command 202 may be configurable based on supplemental information 212. For example, supplemental information 212 may include information regarding classifications of invokers of unified interface command 202, such as the user, the data processing system, and/or other devices that may invoke commands issued by the data processing system. The classifications may establish minimum levels of compliance with the organizational standards. Supplemental information 212 (e.g., security standards and/or other organization standards or policies) may be used to guide modification of unified interface command 202 in a manner that improves compliance with the security standards and/or other organizational standards and policies.

In a first example, if a user invokes a command that requests services from an external provider in a manner that violates a data security standard for the data processing system, then the command may be modified based on a classification that establishes a minimum level of compliance with the data security standard. For example, the command may be modified to enforce the data security standards by (i) forcing data encryption, (ii) activating password requirements, (iii) filtering (e.g., removing) sensitive data, and/or (iv) by performing other types of modifications. The modified command may reflect the minimum level of compliance with the data security standard indicated by supplemental information 212.

In a second example, the invoked command may violate cost policies for the data processing system (and/or the invoker of the command). During interfacing process 208, the command may be modified in a manner that reflects minimum level of compliance with the cost policy. For example, the command may be modified to enforce the cost policy by limiting certain functionality of the service (e.g., a data processing service may be performed using linear regression rather than using more costly methods such as artificial intelligence).

Thus, during interfacing process 208, unified interface command 202 may be modified using the schema associated with the identified external provider, supplemental information 212, and/or other information to obtain selected resource command(s) 214 (e.g., the modified command). For example, unified interface command 202 may include any number of commands (e.g., a sequence of commands), and may be translated to one or more selected resource command(s) 214 executable by the identified external provider. Selected resource command(s) 214 may be specific to the identified external provider. For example, other external providers of the set of external providers may be unable to natively execute selected resource command(s) 214.

Selected resource command(s) 214 may be made available to the external provider and/or to other systems in order to initiate execution of selected resource command(s) 214 by at least the external provider. Upon execution, the requested service may be obtained by the data processing system in compliance with the organizational standards of the data processing system.

By using schemas from schema repository 210 and/or supplemental information 212 as plug-ins to guide modification of unified interface command 202, the computer-implemented services may be facilitated without a need for altering core code of the data processing system. Doing so may reduce a likelihood of user error and/or a need for cumbersome or potentially damaging core code modifications when facilitating requests for the computer-implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flow diagram shown in FIG. 2, command processing for a data processing system may be managed in a manner that (i) reduces communication issues that may be introduced when using services provided by multiple external providers, and (ii) improves compliance of the services with organizational standards.

Turning to FIG. 3, a flow diagram illustrating a method in accordance with an embodiment is shown. The flow diagram may illustrate various operations performed while managing command processing for a data processing system.

At operation 300, an identification that the data processing system has issued a command requesting a computer-implemented service may be made. The identification may be made by (i) obtaining a notification indicating that the command has been issued, (ii) screening commands issued by the data processing system to identify commands that request computer-implemented services, and/or (iii) by other methods. The requested computer-implemented service may be provided by at least one external provider of a set of external providers. The command may be similar to unified interface command 202 of FIG. 2.

At operation 302, based on the identification, an external provider of the set of external providers may be identified based on the requested computer-implemented service and supplemental information associated with the command. The external provider may be identified by (i) performing a resource selection process (similar to resource selection process 206 of FIG. 2), (ii) obtaining a message (e.g., from another device) that identifies the external provider, and/or (iii) by other methods.

For example, the command may be analyzed to obtain information regarding the requested computer-implemented service usable in obtaining a list of external provider candidates that provide the requested computer-implemented service. The supplemental information may be used to select an external provider from the list of external provider candidates that is most likely to provide the computer-implemented service in accordance with organizational standards and/or policies. Refer to the discussion of resource selection process 206 of FIG. 2 for more information regarding identification of an external provider.

The command may not be natively executable by the identified external provider, therefore a modified command that is natively executable by the external provider may be obtained based on the command.

At operation 304, the command may be modified based on a schema for the external provider. The command may be modified by performing an interfacing process similar to interfacing process 208 and/or by other methods. For example, the command may be modified using the schema for the external provider that is associated with the requested computer-implemented service (e.g., based on a type of the computer-implemented service) and/or the supplemental information by (i) adding (e.g., appending, inserting) instructions to the command to reflect constraints of a user and/or the supplemental information, (ii) replacing portions of syntax of the command with different syntax (e.g., recognized by the external provider and as defined by the schema), and/or (iii) using other methods to obtain a modified command based on the command. Refer to the discussion of interfacing process 208 of FIG. 2 for more information regarding modification of commands for external providers.

At operation 306, execution of the modified command by at least the external provider may be initiated to facilitate provisioning of the requested computer-implemented service. The execution of the modified command may be initiated by (i) providing the modified command to the external provider (e.g., directly and/or via another device), (ii) inserting the modified command into an execution flow for commands issued to the external provider, and/or (iii) other methods. The modified command may be natively executable by the external provider and therefore may facilitate provision of the requested computer-implemented service.

For example, the computer-implemented service may be facilitated and/or provided, in part, upon execution of at least a portion of instructions of the modified command by (at least) the external provider. The external provider and/or another device may execute portions of instructions of the modified command in cooperation with execution of other instructions in order to provide the computer-implemented service.

The method may end following operation 306.

Thus, as illustrated above, embodiments disclosed herein may provide systems and methods usable to manage interactions between a data processing system and multiple external providers using schemas to automate command processing. By doing so, the interactions may be standardized at the user level in order to reduce complications when accessing services of the external providers.

Thus, embodiments disclosed herein may provide an improved computing device that may automatically modify commands in a manner that reduces a likelihood of interruptions to the computer-implemented services and that increases a likelihood of compliance of the computer-implemented services with respect to organizational standards. Accordingly, the disclosed process provides for both an embodiment in computing technology and an improved method for managing command processing for the data processing system.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing command processing for a data processing system, the method comprising:
making an identification that the data processing system has issued a command, the command requesting a computer-implemented service, and the computer-implemented service being provided by at least one of a set of external providers; and
based on the identification:
identifying an external provider of the set of external providers based on the requested computer-implemented service and supplemental information associated with the command;
modifying the command based on a schema for the external provider; and
initiating execution of the modified command by at least the external provider to facilitate provisioning of the requested computer-implemented service.

2. The method of claim 1, wherein the supplemental information comprises security standards, and the command is modified based at least on the security standards to improve compliance with the security standards.

3. The method of claim 2, wherein the supplemental information comprises information regarding classifications for invokers of commands issuable by the data processing system, each of the classifications establishing minimum levels of compliance with the security standards for modified commands that are based on the commands, and the command is modified also based on a minimum level of compliance of the minimum levels of compliance corresponding to an invoker of the invokers that invoked the command.

4. The method of claim 3, wherein the supplemental information is defined, at least in part, by an administrator tasked with the managing of the command processing using the set of the external providers and the administrator is different from the invoker.

5. The method of claim 1, wherein each external provider of the set of external providers provides computer-implemented services using an application protocol interface.

6. The method of claim 5, wherein application protocol interfaces of the set of external providers differ from one another and are controlled exclusively by the set of external providers.

7. The method of claim 1, wherein the schema for the external provider is adapted to translate the command to the modified command using command mappings defined by the schema, the command mappings being based on an application protocol interface of the external provider.

8. The method of claim 7, wherein the schema is a member of a schema repository comprising a plurality of schemas for the set of external providers.

9. The method of claim 1, wherein the command is issued based on a command template of a repository of command templates, the command template being associated with the requested computer-implemented service.

10. A non-transitory machine-readable medium having instructions stored therein, which when executed by a processor, cause the processor to perform operations for managing command processing for a data processing system, the operations comprising:
making an identification that the data processing system has issued a command, the command requesting a computer-implemented service, and the computer-implemented service being provided by at least one of a set of external providers; and
based on the identification:
identifying an external provider of the set of external providers based on the requested computer-implemented service and supplemental information associated with the command;
modifying the command based on a schema for the external provider; and
initiating execution of the modified command by at least the external provider to facilitate provisioning of the requested computer-implemented service.

11. The non-transitory machine-readable medium of claim 10, wherein the supplemental information comprises security standards, and the command is modified based at least on the security standards to improve compliance with the security standards.

12. The non-transitory machine-readable medium of claim 11, wherein the supplemental information comprises information regarding classifications for invokers of commands issuable by the data processing system, each of the classifications establishing minimum levels of compliance with the security standards for modified commands that are based on the commands, and the command is modified also based on a minimum level of compliance of the minimum levels of compliance corresponding to an invoker of the invokers that invoked the command.

13. The non-transitory machine-readable medium of claim 12, wherein the supplemental information is defined, at least in part, by an administrator tasked with the managing of the command processing using the set of the external providers and the administrator is different from the invoker.

14. The non-transitory machine-readable medium of claim 10, wherein each external provider of the set of external providers provides computer-implemented services using an application protocol interface.

15. The non-transitory machine-readable medium of claim 14, wherein application protocol interfaces of the set of external providers differ from one another and are controlled exclusively by the set of external providers.

16. A data processing system, comprising:
a processor; and
a memory coupled to the processor to store instructions, which when executed by the processor, cause the processor to perform operations, the operations comprising:
making an identification that the data processing system has issued a command, the command requesting a computer-implemented service, and the computer-implemented service being provided by at least one of a set of external providers; and
based on the identification:
identifying an external provider of the set of external providers based on the requested computer-implemented service and supplemental information associated with the command,
modifying the command based on a schema for the external provider, and
initiating execution of the modified command by at least the external provider to facilitate provisioning of the requested computer-implemented service.

17. The data processing system of claim 16, wherein the supplemental information comprises security standards, and the command is modified based at least on the security standards to improve compliance with the security standards.

18. The data processing system of claim 17, wherein the supplemental information comprises information regarding classifications for invokers of commands issuable by the data processing system, each of the classifications establishing minimum levels of compliance with the security standards for modified commands that are based on the commands, and the command is modified also based on a minimum level of compliance of the minimum levels of compliance corresponding to an invoker of the invokers that invoked the command.

19. The data processing system of claim 18, wherein the supplemental information is defined, at least in part, by an administrator tasked with managing command processing for the data processing system using the set of the external providers and the administrator is different from the invoker.

20. The data processing system of claim 16, wherein each external provider of the set of external providers provides computer-implemented services using an application protocol interface.
